(19) United States
(12) Patent Application Publication
(10) Pub. No.: US 2005/0015617 A1
(43) Pub. Date: Jan. 20, 2005

(54) Internet security

(76) Inventor: Peter Olof Karsten, Windsor (GB)

Correspondence Address: Flynn, Thiel, Boutell & Tanis, P.C., 2026 Rambling Road, Kalamazoo, MI, 49008-1631, US

(21) Appl. No.: 10/482,609

(22) PCT Filed: Jun. 21, 2002
(86) PCT No.: PCT/GB02/02852

(30) Foreign Application Priority Data
Jun. 29, 2001 (GB) 0116069.6

(51) Int. Cl. H04L 9/00

(52) U.S. Cl. 713/201

(57) ABSTRACT

In a communications system in which an incoming email is received at an email server within a secure domain, the incoming email is copied to a secondary server outside that secure domain. The copy email message can then be retrieved from the secondary server from a remote device outside the secure domain.

Email and email messages are terms which are used broadly to describe digital messages which are transmitted over Internet protocol networks or generated using data residing in personal information management applications such as calendar, contact or task list applications. Such digital files may include text, voice or images or any combination of these.

Email messages are delivered to an email server and can be retrieved by means of a personal computer (‘PC’) which is a client of the server. If the PC leaves a copy of an email message on the server, then other clients can retrieve the email message. This can be useful where, for example, a subscriber wishes to be able to retrieve email messages from both home and office.

However, there is a security risk arising from this free access between computers, especially over an area as wide as the Internet.

Many corporate computer systems are protected from remote access by means of a corporate firewall. Corporations tend to keep both client PCs and email servers inside firewalls on relatively secure local area networks. These ‘islands’ of security are called secure domains. Whilst this level of security is useful, it does tend to prevent the accessing of email by remote clients, including for example a subscriber's home PC. Although some corporate information technology departments do provide methods for secure remote access to email messages, these methods tend to rely on accessing email messages from a predetermined remote site.

It is still, in general, difficult to arrange remote access to email messages within a secure corporate domain, particularly where access is to be obtained from a range of non-secure locations or PCs. Information stored in multiple locations in a long-term manner also presents targets which can be attacked multiple times at its weakest or least controlled points.

The invention provides a system and software intended to assist in remote accessing of email messages held within a secure domain.

The invention may, furthermore, make email messages when there is an indication that the end-user can retrieve the e-mail. There exists a protocol specification called Session Initialisation Protocol (‘SIP’) which has been defined for UMTS third generation telecommunication networks which supports a concept called ‘Presence’ by which an end-user's availability to communicate is indicated. SIP is going to be the standard signalling protocol/mechanism to support Voice Over IP (‘VOIP’) for third generation networks.

There are available multiple ways to show Presence, that is, that a user is present. However, a preferred system in accordance with the invention uses the SIP presence concept to implement Presence. An end-user's Presence may have associated with it parameters such as time, location and the type of interface available to the end user. The Presence parameters may also include local addressing information for the user interface device in use, such as, for example, a Bluetooth device address. Presence is envisaged to be provided by a Presence server which, typically, resides outside the corporate firewall. If an end-user's Presence is true, then the end user is said to be Present.

In accordance with the invention, there is provided a communication system in which an incoming email received at an email server within a secure domain is copied to a secondary server outside that secure domain if the end user is Present, so that the copy email‘message can be retrieved therefrom from a remote device outside the secure domain.

Preferably, an end-user's email is only copied to the secondary server when the end-user is Present. A screensaver application at the remote device or at the PC client can be used as input to the Presence server so that the screensaver status forms part of the Presence parameters.

A record of the copied email may be kept at the PC client so that changes in the end-user's Presence can be used as basis for sending a request for deletion of the email at the secondary server.

Preferably, the copy email message is encrypted using the public key of a public/private key pair and the remote device contains the private key thereof to enable to retrieved message to be decrypted.

In a further embodiment, the system provides means for copying a part of the incoming email message and sending it to the secondary email server so that the copied part of the message acts as a prompt to alert the user of the remote device that the full message is awaiting retrieval.

Alternatively, the email server may generate a prompt message and send it to the secondary server so that the prompt-message serves to alert the user of the remote device that the full message is awaiting retrieval.

An embodiment of the system of the invention will now be described in detail, by way of example, with reference to the drawing, which is a schematic diagram illustrating the architecture of a system in accordance with the invention.

Software provided in accordance with the invention analyses incoming email messages arriving at a secure domain and forwards a copy of any incoming email message to a secondary email server which is outside the secure domain. The secondary server stores the email: message and can send a copy of it through wired and/or wireless networks to the remote access client device. The remote access client device may also access the secondary server in order to retrieve email messages.

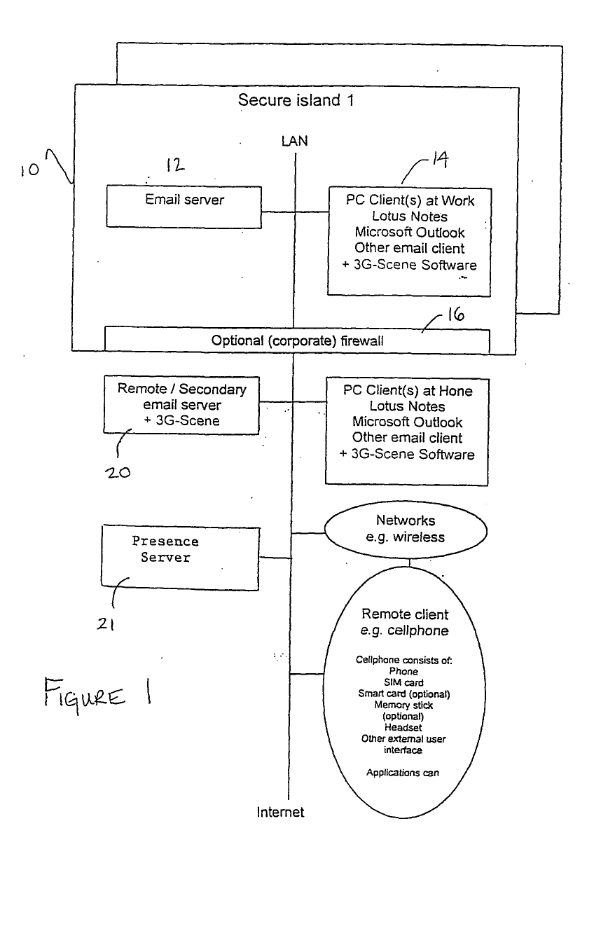

As can be seen in FIG. 1, an incoming email message is received at a ‘corporate’ email server 12 which is located within a secure domain 10 within which are to be found not only the server 12 but also, perhaps, a local area network (‘LAN’) and the client PC, that is the subscribers office/work PC 14. The secure domain 10 is protected against unauthorised access by means of firewall software shown at 16.

The LAN and PC client 14 may run on any suitable software for Internet applications, for example, Microsoft Outlook or Lotus Notes.

The software of the invention, which is installed at the client PC is copied and sent to a remote secondary server 20 located outside the secure domain 10. Separate email sending software (for example, an smtp client) may be installed at the email server 10 so that normal operation of the email client is not affected.

As mentioned above, in a preferred system in accordance with the invention, an end-user's email may only be copied to the secondary server when the end-user is Present. The system uses the SIP presence concept to implement Presence using a Presence server (21) which, typically, resides outside the corporate firewall 16.

The software of the invention is provided with the public key or a certificate containing the public key of a public/private key encryption system of the subscriber to whom the email copy will ultimately be sent and the copy of the email message sent to the secondary server 20 is encrypted using the public key in question.

The secondary email server 20 can forward the email to the remote client and/or home PC client or alternatively can allow a remote client or home PC client to retrieve the email message. The secondary server 20 can encrypt messages for multiple next email clients each of which will be the only device which is able to decrypt the message intended for it. If the email message is encrypted specifically for the first client device, then that client device may automatically decrypt the message with its own private key and then forward it to the next email client.

One problem which arises in systems of this kind is to ensure that; incoming email messages are securely and promptly made available to a remote client device which is only available intermittently. Some remote devices, such as mobile phones may, further, have only limited capability to receive/store and/or display information. Security is, of course, a particular problem where email messages are encrypted.

As mentioned above, the email message is encrypted using the public key as mentioned above A part of the email copy and/or a message such as the sender's telephone number is encrypted using the same public key so as to reduce the message size and overcome the potential limitations posed by devices with low storage capacity (mobile phones). The message is intended to be sent to which ever remote device is most available to the subscriber or end user (the ‘prompt device’).

The resulting encrypted prompt message is sent to the secondary server 20 by the separate email sending software at the email server 12. The prompt message is delivered to the prompt device as soon as possible. It can only be decrypted using the private key in the prompt device. The prompt message gives the end user information about the arrival of the email message and/or information about the email message (such as the sender's name) and/or information about how to access the email message (such as a password).

In a preferred embodiment, the choice of public/private key pair used is related to Presence parameters and the remote device contains a private key related to the end user's Presence to enable the message to be decrypted.

The Presence parameters may also be used to determine which part or parts of the email message should be copied and sent to the secondary server.

The system permits multiple prompt devices with the same or multiple public/private key pairs.

Using a remote email client device, such as a laptop PC, the end user can retrieve the email message copy from the secondary server 20 which can then be decrypted using the private key in that device.

By modifying the key used to encrypt the data, it is possible to utilise the system of the invention to provide data under special conditions so that the system can meet a number of other needs as well.

In some circumstances it may be desirable to provide information securely so that it can be accessed only at a given location or to provide information which is location dependent. For example, information about events at a sports arena might be made available only to remote devices in the immediate surroundings of the arena

The system of the invention can be adapted to meet this need.

Information is encrypted using an encryption key which is location information. For example, a cellular (mobile) phone operates within a ‘cell’around a base station(s). The identity an/or communication characteristics of the base station(s) can be used to form a data string which functions as a decrypting key.

The server which transmits information to the remote device may know the resulting decrypting key or the device may, as a preliminary step, retrieve location-related information and send the location information to the server. If the device retrieves the location information, then the device may perform calculations based on the retrieved location information and send the results of the calculations to the server. The device can send the results only to the server.

The device may encrypt the location information before sending the data.

Information describing the person using the remote device, the time and/or the characteristics of the device itself may be merged with the location-related information to define more clearly the end user's characteristics. Again this information, representing the end-user characteristics, is used to define the encryption key used by the server which sends information to the remote device.

The end user might also put in temporary information, such as a pin number, to render the device available temporarily for the information service provided to that location.

Where the remote device is a wireless device, the remote device's position needs to be calculated without changing anything in the wireless network. Although a wireless device such as mobile phone has limited memory, the phone is aware of some data relating to its position in today's networks. This data is the timing advance for the base station to which it is connected at the time the measurement is conducted, and also both signal strengths and base station cell identity for all cells in the area (including but not limited to the one to which the cellphone is connected at the time in question).

The data can be made available to an application which resides in the phone. The application can poll for the data intermittently, or the data can be automatically streamed to the application.

The application can then act on the basis of the location dependent data that it has received.

The application may forward the measurement data to a server that resides in the network. This allows the server in the network to use a database with information about base station locations to calculate the position of the wireless device. The server would thus contain both database and location calculation software, and off-load the wireless device to allow the wireless device to be small and cheap to manufacture.

The server application may request the location data, or the application on the phone may automatically forward the data to the server.

The server may sign the location data request using e.g. RSA digital signature algorithms, and the phone then verifies the signature prior to acting on the request, using e.g. the public key of the server. This would prevent unauthorised access to a phone's location.

The phone application may encrypt the location information so that only the intended recipient is able to decrypt it. The phone application may also sign the location information, either automatically or with user PIN input, to verify that this phone and/or user are indeed at this location. The above could subsequently be time stamped to verify the time at which the phone and/or user were at the location in question.

All of the above could be done with servers and phones that are not part of the existing wireless networks with no other impact than a slight increase in “traffic-as-usual” In the system of the invention, it is also possible to adapt the encryption key in such a way that services or information may be made available only to end users who possess a given combination of two devices, for example, a SIM and a phone.

This can be implemented without added security mechanisms by providing an application which resides in the first device, for example, the phone which can read data from the second device (the SIM). Alternatively, the second device (the SIM) may provide data to the first device which can be read by the application found in the first device. The application is such that it is only executable in a complete manner if the application has successfully read the data from the second device.

In order to give the user a positive experience even in cases where the two devices have not been correctly combined, the application residing in the first device may be such that it can execute along an alternative path providing a subset rather than the complete user experience, with indicators to cover the areas not made available. The user may, if the indicators are friendly enough, remain unaware that they have not received the full information or experience.

Where additional security is required, information is encrypted with an encryption key which is calculated with information which is fixed and related to both devices, that is, in the example given, the phone and the SIM.

For example, a customer may be able to access interactive services using a mobile phone with a given SIM. All information sent by the server to the device, mobile phone or SIM, is encrypted with the special encryption key referred to above. The information can only be decrypted when the subscriber has information to hand about both devices so as to calculate a decryption key.

Where it is desired by an email client in a fixed location to deliver information to a mobile end user in a non-obtrusive manner, the email client can automatically send a status request to a device carried by the end user or to a proxy server that represents the end user. The client device or proxy server responds with status information such as location or local time settings. The email client can then have pre-set rules that define how and where to deliver the information.

Some devices have multiple user interfaces. For example, the Nokia 9210 has a small front screen and large internal screen. It may be necessary, therefore, to make information available only to chosen user interfaces.

This can be achieved by using the XML and/or XHTML style sheets that relate to each user interface as the decrypting keys.

It would also be useful if people who have not used a PC for a while be alerted that something has happened on the PC. This could be achieved by using the screensaver feature on a PC to trigger the activation of email monitoring software. The email monitoring software can then forward incoming email or other events (such as calendar events) to the user's mobile phone by SMS.

Preferably, the email monitoring software can be made in such a way that locking the PC has no effect on the activities of the email monitoring software. Thus, even where a PC has been locked, a person who locked their PC after requesting alerts can still be alerted.

It may also be desirable to alert a person who is away from their PC to the presence of an incoming email message while keeping the PC secure from undesired access. Where this is necessary, the LOCK PC feature on a PC can be used to trigger the activation of email monitoring; software which can then forward incoming email or other events (such as calendar events) to the users mobile phone by SMS.

1. A communication system in which an incoming email received at an email server within a secure domain is copied to a secondary server outside that secure domain if the end user is Present so that the copy email message can be retrieved therefrom from a remote device outside the secure domain.

2. A system according to claim 1 in which the email copy sent to the secondary server contains parameters which allow an application at the secondary server to use changes in the end-user's Presence parameters to activate email availability limitations or to delete the email.

3. A system according to claim 1 in which the copy email message is encrypted using the public key of a public/private key pair and the remote device contains the private key thereof to enable to retrieved message to be decrypted.

4. A system according to claim 3 in which the choice of public/private key pair used is related to Presence parameters and the remote device contains a private key related to the end user's Presence to enable the message to be decrypted.

5. A system according to claim 1 including means for copying a part of the incoming email message and sending it to the secondary email server so that the copied part of the message acts as a prompt to alert the user of the remote device that the full message is awaiting retrieval.

6. A system according to claim 5 including means for using the Presence parameters to determine which part or parts of the email message should be copied and sent to the secondary server.

7. A system according to claim 1 in which a record of the copied email is kept at a PC client associated with the email server so that changes in the end-user's Presence can be used as basis for sending a request for deletion of the email at the secondary server.

8. A system according to claim 1 in which a screensaver application at the remote device or at the PC client is used as input to the Presence server so that the screensaver status forms part of the Presence parameters.

9. A system according to claim 2 in which a key used to encrypt the message or a part of the message is created dynamically using the Presence parameters of the remote device for which it is intended so that the email message or part thereof can only be decrypted by a remote device having the same Presence parameters.

10. A system according to claim 1 in which an email message can be decrypted or retrieved by a remote access device only when the Presence parameters of the remote device have been associated with the Presence parameters of at least one other device; a key used to encrypt the data being dependent on the Presence parameters of both the remote device and the said at least one other device.

11. A system according to claim 9 in which the decryption of the email message at the remote device is used to activate a notification application which notifies other devices or servers about the Presence parameters of the decrypting remote device at the time of decryption.

12. A system according to claim 1 in which an email message can be retrieved only by a remote access device when it is associated with a second device; the key used to encrypt the data being dependent on information from or relating to both devices.

13. A system according to claim 1 in which the key used for decryption of the email message carries information relating to interfaces available at the remote access device and only permits decryption of messages intended only for a predetermined interface or interfaces.

14. A communication system in which an incoming email received at an email server within a secure domain is copied to a secondary server outside that secure domain so that the copy email message can be retrieved therefrom from a remote device outside the secure domain.

15. Computer software recorded in machine readable form for implementing the system of claim 1.
